(19) United States
(12) Patent Application Publication
(10) Pub. No.: US 2009/0056864 A1
(43) Pub. Date: Mar. 5, 2009

(54) SHEET-FED ROTARY PRINTING PRESS AND EMBOSSING METHOD

(75) Inventor: Thomas WALTHER, Offenbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: manroland AG, Offenbach (DE)

(21) Appl. No.: 12/243,643

(22) Filed: Oct. 1, 2008

Related U.S. Application Data
(63) Continuation of application No. PCT/EP2007/002316, filed on Mar. 16, 2007.

(30) Foreign Application Priority Data
Apr. 1, 2006 (DE) 102006015256.5

(51) Int. Cl. B44C 1/16

(52) U.S. Cl. 156/234

(57) ABSTRACT

A method that combines a cold film transfer method with an inline embossing apparatus within a sheet-fed printing press is provided. The method includes the step of applying an adhesive coating to image areas on a printed sheet using an application mechanism. The printed sheet with the adhesive is conducted to a coating module. Image-forming layers are transferred from a transfer film that is guided through a transfer nip defined by an impression cylinder and a pressing roller in the coating module. The transfer film is guided through the transfer nip in such a way that a side of the transfer film coated with an image forming layer lies on the printed sheet guided on the impression cylinder and is guided together with the printed sheet under pressure through the transfer nip. The image-forming layer adheres in the image areas provided with adhesive on the printed sheet and is lifted from the carrier film. The printing sheet is mechanically shaped by embossing in the coating module simultaneously with the transfer of the image-forming layer onto the printed sheet in the transfer nip of the coating module.

### CROSS-REFERENCE TO RELATED APPLICATIONS

This patent application is a continuation of International Patent Application PCT/EP2007/002316, filed Mar. 16, 2007, which claims priority to German Patent Application No. 102006015256.5, filed Apr. 1, 2006, both of which are hereby incorporated by reference in their entirety.

### FIELD OF THE INVENTION

The present invention relates generally to an embossing method that is carried out inline during passage of printing sheets through the printing press.

### BACKGROUND OF THE INVENTION

All film printing methods involve partially applying a film, under pressure, onto a printing substrate (e.g., paper, cardboard, or film in the form of sheets or rolls) and is permanently fixed. The printing films can include films with a gold or silver gloss, but printing films in various colors with high gloss or silk gloss surfaces are also known. The application of the printing film on the substrate takes place using primarily an embossing film printing or hot film embossing printing technique. This printing technique is generally similar to an intaglio printing method and is, in this respect, similar to book printing. A significant common feature of these techniques is that the printing portions of the printing plate are higher than the surrounding nonprinting portions. During the printing process, the printing plate is indirectly heated and maintained at a constant temperature. The printing medium transferred from the printing film to the substrate consists of a transfer layer, in the form of a thin, multilayer, dry film, that is detachably affixed on a substantially transparent carrier film by a separation layer. The transfer layer, in turn, is made in two plies or layers including a silver-colored aluminum vapor-deposition and a mostly colored lacquer layer. This double transfer layer construction is also provided with a synthetic resin, which becomes adhesive when heated.

During the printing process, the transfer film is conducted through the printing mechanism together with the substrate to be imprinted. There the transfer layer is detached from the carrier film and is transferred onto the substrate by the contact pressure of the heated printing plate on the sites defined by the elevated elements of the printing plate. Due to the heat transferred by the printing plate, the separation layer between the carrier film and the transfer layer evaporates so that the transfer layer is easily detached from the carrier film. The synthetic resin layer is activated by the heat from the dry to an adhesive state such that the synthetic layer forms an adhesive layer between the substrate and the transfer layer. As a result, the transfer layer (e.g., a gold-gleaming layer) adheres permanently to substrate at the sites defined by the printing plate.

A disadvantage with this known film printing method is that it takes a very long time to prepare and setup the printing plate or block. The preparation and setup time can account for almost half the total production time, the known film printing method is very time consuming as a whole and thus connected with high production costs.

A disadvantage of known embossing methods is that the embossing process does not take place during passage through the printing press. Instead, the embossing generally takes place during subsequent processing, in that the printed sheet is conducted to a subsequent processing machine with a hot film embossing device. Another disadvantage is that the substrate can no longer be appropriately imprinted after the transfer of the film in the hot film embossing device since the film has an uneven structure due to the embossing process. Also, after the embossing process, the printed sheet would have to, once again, be conducted to a printing process for colored imprinting resulting in longer production times and higher production costs result.

The imprinting of an applied film, however, is a desirable process, since it can attain a large number of metallic effects without the necessity of using special films. For example, in order to attain a blue metallic effect in a car brochure to illustrate a blue metallic lacquering of the car, a special blue film would have to be arranged and transferred in the known hot embossing method. In contrast, in a film transfer method that permits a subsequent imprinting, a standard silver film can be transferred that is then imprinted with a blue printing ink in order to attain the blue metallic effect. Such a process is much more economically sensible than storing a large number of special films. In particular, economic savings can be attained by buying larger quantities of one type of film in bulk. Additionally, the lead times associated with ordering the special films can be eliminated.

EP 0 578 706 B1 describes a so-called cold film transfer method in which the printed sheet is provided via a printing mechanism with an adhesive layer on the sites where the subsequent transfer layer is to adhere. After the application of the adhesive, the transfer of the film takes place in another step by bringing the film with the transfer layer thereon into pressure contact with the printed sheet in another printing mechanism. In this step, the adhesive on the stock detaches the transfer layer from the film.

This transfer method is very economical since it can be carried out inline in a printing press without limiting the production speed. This method also eliminates the expensive production of the embossing punch that is necessary for performing the hot film embossing printed method. It is possible to imprint such a film inline during passage through the printing press, so that a large number of colored effects can be attained in an economically sensible manner. The disadvantage of this method is that many consumers miss the three-dimensional feel of the hot film embossing, since the transferred transfer layer essentially lies flat on the stock.

The method of embossing printed sheets during passage through the printing press is very well known from a large number of patents and patent publications. Thus, for example, the patent publications and patents DE 465792, DE 4138277 C2, and DE 19826974 C2 deal with the embossing of printed sheets inline during passage through a printing press.

In addition, WO 2005/049322 describes a process combining the cold film transfer method with inline embossing in which the embossing step takes place in a method step upstream or downstream from the cold film transfer during passage through the printing press. A disadvantage of this process is that at least one coating module and one embossing unit are needed and thus the press becomes longer and more expensive.

DE 10 2005 011 697 A1 describes the combination of a cold film transfer device with a separate embossing device associated with the coating module. A disadvantage of this arrangement is that a printing of the transfer layer is possible only to a limited extent later, since the elevations could be flattened during the passage through additional printing mechanisms by the pressure exerted during the printing process, A separate device for the application of an embossing is also cumbersome and is difficult to integrate into the printing press.

### OBJECTS AND SUMMARY OF THE INVENTION

In view of the foregoing, an object of the invention is to combine the cold film transfer method known from, among other places, EP 0 578 706 B1, with an inline embossing device within a sheet-fed printing press in such a way that the advantages of the cold film transfer, namely, the economical transfer technique and the subsequent capacity to print over it, are combined with the three dimensional feel and appearance of a hot film embossing print.

### BRIEF DESCRIPTION OF THE SEVERAL VIEWS OF THE DRAWING(S)

FIG. 1 is a schematic side view of a printing press configured according to one embodiment of the present invention.

FIG. 2 is a schematic side view of a printing press configured according to another embodiment of the present invention.

### DETAILED DESCRIPTION OF THE INVENTION

According to the invention, an embossing process can take place simultaneously with the transfer of a film layer in a coating module configured to carry out a cold film transfer method. To this end, a pressing roller, for example, the blanket cylinder of the coating module for carrying out the cold film transfer method, is covered with an embossing plate having embossing elements (male plate). The embossing elements define elevations that at least cover the surface portions that are provided for the transfer of the transfer layer. In most cases, the portion of the plate with the elevated surface embossing elements can correspond to the area of the printed sheet which was defined by the adhesive application that preceded the coating module. If desired, however, the portion of the plate with the elevated surface embossing elements can be larger than the area defined by the adhesive application. Alternatively, the impression cylinder can also be covered with an embossing plate with elevated embossing elements (male plate). The opposing surface to the embossing plate with the elevated embossing elements can be an elastic substrate or an embossing plate with indentations (female plate).

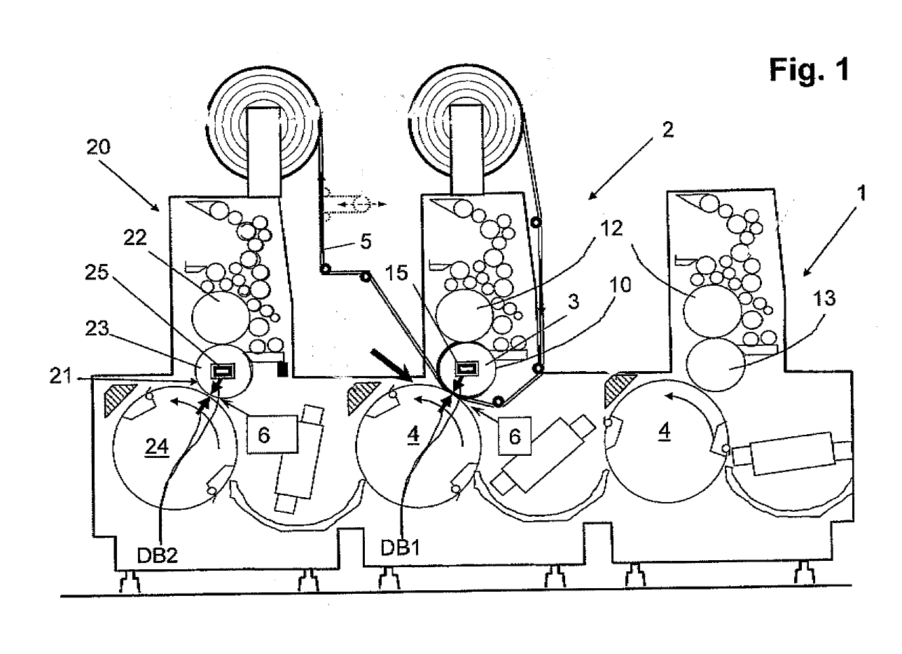

Referring to FIG. 1 of the drawings, an illustrative embodiment of a printing press configured according to the invention is shown. In the first printing unit 1, an adhesive can be attached via a printing operation onto a substrate such a printed sheet of paper To this end, the first printing unit 1 includes a plate cylinder 12 and a blanket cylinder 13. In the second printing unit, which in this case is configured as a foil transfer unit 2, a transfer foil 5 is pressed via a pressing roller 3 in a pressing nip 6 against the impression cylinder 4 such that a foil layer is transferred from the transfer foil 5 to the printed sheet. In this instance, the printing functionality of the second printing unit 2 is disabled.

To apply the necessary pressure in the pressing nip 6, the pressing roller 3 includes a surface packing 10 that forces the transfer foil 5 against the printed sheet. The surface packing 10 of the pressing roller 3 can further include elements for embossing the foil against the printed sheet to thereby form a three dimensional pattern or texture in the printed sheet simultaneously with the foil transfer.

Alternatively, the forming of the three-dimensional shaped surface or partial surface of the substrate may occur in a third printing unit 20 that includes a plate cylinder 22, a blanket cylinder 23 and an impression cylinder 24. In such a case, the printing functionality of the third printing unit 20 should be disabled. In the third printing unit 20, the embossing elements may be attached to a surface packing 21 of the blanket cylinder 23. The embossing elements in the third printing unit 20 may correspond with the areas that were printed or subject to a foil transfer in the second printing unit 2. It is preferred, however, that the embossing elements be integrated into the foil transfer unit 2 so that the foil 5 is transferred and the three dimensional surface structure or texture is produced in the printed sheet at the same time and in the same area of the printed sheet.

The pressure or embossing force that is applied to the printing substrate or sheet in the pressing stations DB1 or DB2 may be controlled by devices 15, 25 at the pressing roller 3 or blanket cylinder 23, respectively.

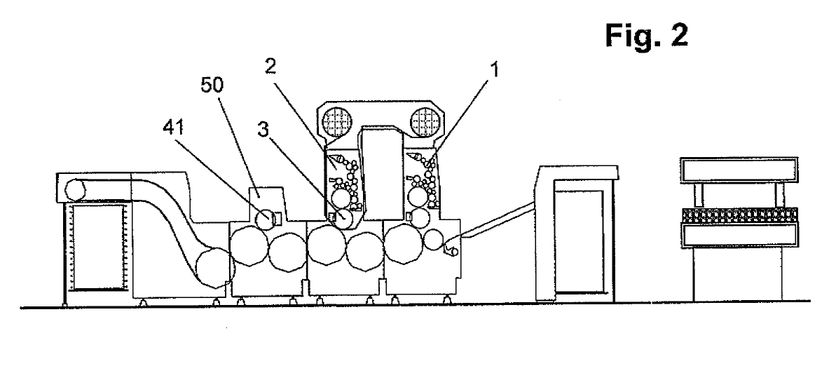

FIG. 2 illustrates a printing press in which a third printing unit 50 is arranged as a coating module. Embossing elements can be provided in the surface of a form cylinder 41 in the third printing unit in order to produce a three dimensional pattern or texture in the printed sheet that has been provided with transferred foil elements.

1. A method for coating of a printed sheet in a sheet-fed printing press comprising the steps of:
applying an adhesive coating to image areas on a printed sheet using an application mechanism;
conducting the printed sheet with the adhesive to a coating module;
transferring image-forming layers from a transfer film that is guided through a transfer nip defined by an impression cylinder and a pressing roller in the coating module, the transfer film being guided through the transfer nip in such a way that a side of the transfer film coated with an image forming layer lies on the printed sheet guided on the impression cylinder and is guided together with the printed sheet under pressure through the transfer nip, wherein the image-forming layer adheres in the image areas provided with adhesive on the printed sheet and is lifted from the carrier film; and
mechanically shaping the printing sheet by embossing in the coating module simultaneously with the transfer of the image-forming layer onto the printed sheet in the transfer nip of the coating module.

2. The method according to claim 1, wherein the step of mechanically shaping the printed sheet is performed such that the printed sheet has an embossed structure with a height/depth ratio greater than 0.02 mm.

3. The method according to claim 1, wherein the pressing roller or the impression cylinder of the coating module carries an embossing plate with elevations and wherein a contact surface defined by the elevations of the embossing plate is substantially identical to the image areas provided with adhesive on the printed sheet.

4. The method according to claim 1, wherein the pressing roller or the impression cylinder of the coating module carries an embossing plate with elevations and wherein a contact surface defined by the elevations of the embossing plate is larger in surface area than the image areas provided with adhesive on the printed sheet.

5. The method according to claim 1, wherein the pressing roller or the impression cylinder of the coating module carries an embossing plate with elevations and wherein a contact surface defined by the elevations of the embossing plate is smaller in surface area than the image areas provided with adhesive on the printed sheet.

6. The method according to claim 1, wherein the pressing roller or the impression cylinder of the coating module carries an embossing plate with elevations and wherein a contact surface defined by the elevations of the embossing plate covers a partial section of the image areas provided with adhesive on the printed sheet.
